(19) United States
(12) Patent Application Publication
(10) Pub. No.: US 2010/0224829 A1
(43) Pub. Date: Sep. 9, 2010

(54) PHOSPHOR

(75) Inventors: Yutaka Ito, Tsukuba-shi (JP); Koutoku Ohmi, Tottori-shi (JP); Akira Yamane, Tottori-shi (JP); Atsushi Kobayashi, Tottori-shi (JP); Takashi Kunimoto, Kurayoshi (JP)

Correspondence Address: SUGHRUE MION, PLLC, 2100 PENNSYLVANIA AVENUE, N.W., SUITE 800, WASHINGTON, DC, 20037, US

(73) Assignees: SUMITOMO CHEMICAL COMPANY, LIMITED, Chuo-ku, Tokyo (JP); NATIONAL UNIVERSITY CORPORATION TOTTORI UNIVERSITY, Tottori-shi ,Tottori (JP)

(21) Appl. No.: 12/675,708

(22) PCT Filed: Aug. 25, 2008
(86) PCT No.: PCT/JP2008/065111

§ 371 Date: Feb. 26, 2010

(30) Foreign Application Priority Data
Aug. 31, 2007 (JP) 2007-225590

(51) Int. Cl. C09K 11/61; C09K 11/59; B05D 5/06

(52) U.S. Cl. 252/301.4 F; 252/301.4 H; 427/66

(57) ABSTRACT

Disclosed is a phosphor having high luminance, which is composed of M¹, M², M³, M⁴, a halogen element and O, wherein M¹ represents an alkaline earth metal; M² represents a trivalent metal element; M³ represents an activating element; and M⁴ represents a tetravalent metal element, with the molar ratio among M¹, (M²+M³), M⁴, and the halogen element, namely M¹:(M²+M³):M⁴: halogen element being 1:4:3:a wherein a is a number within the range of not less than 0.01 but not more than 3. The phosphor can be obtained by firing a metal compound mixture containing M¹, M², M³, M⁴, and a halogen element, wherein M¹, M², M³ and M⁴ are as defined above, which additionally contains one or more halides selected from the group consisting of halides of M¹, halides of M² and halides of M³.

### TECHNICAL FIELD

The present invention relates to a phosphor.

### BACKGROUND ART

Phosphors are used for light emitting devices. The light emitting devices include, for example, electron ray excited light emitting devices in which excitation source for a phosphor is electron ray (e.g., CRT, field emission displays, surface electric field displays, etc.), ultraviolet ray excited light emitting devices in which excitation source for a phosphor is ultraviolet rays (e.g., backlight for liquid crystal displays, three band fluorescent lamps, high load fluorescent lamps, etc.), vacuum ultraviolet ray excited light emitting devices in which excitation source for a phosphor is vacuum ultraviolet rays (e.g., plasma display panels, rare gas lamps, etc.), and white LED in which excitation source for a phosphor is light emitted from blue LED or light emitted from ultraviolet LED, light emitting devices in which excitation source for a phosphor is X ray (X ray image pick-up devices), and the like. Phosphors emit light upon being irradiated with the above excitation sources.

As conventional phosphors, Patent Document 1 discloses phosphors comprising a compound represented by Ca(La,Gd)₄Si₃O₁₃ containing an activator.

Patent Document 1: JP-A-2006-206631

### DISCLOSURE OF INVENTION

### Problem to be solved by the Invention

The above phosphors are sufficient in that the luminance hardly decreases after irradiation with excitation source, but there is still room for improvement in order to obtain phosphors having high luminance. The object of the present invention is to provide a phosphor having further enhanced luminance.

### Means for Solving the Problem

As a result of intensive researches conducted by the inventors in an attempt to attain the above object, the present invention has been accomplished.

That is, the present invention provides the following inventions.

<1> A phosphor which comprises M¹, M², M³, M⁴, a halogen element and O, wherein M¹ represents an alkaline earth metal element, M² represents a trivalent metal element, M³ represents an activating element, and M⁴ represents a tetravalent metal element, with the molar ratio of M¹:(M²+M³):M⁴:halogen element being 1:4:3:a wherein a is a number within the range of not less than 0.01 but not more than 3.

<2> The phosphor described in the above <1> wherein M¹ contains Ba.

<3> The phosphor described in the above <1> or <2> wherein M² contains Gd.

<4> The phosphor described in any one of the above <1>-<3> wherein M³ contains Tb.

<5> The phosphor described in any one of the above <1>-<4> wherein M⁴ contains Si.

<6> The phosphor described in any one of the above <1>-<5> wherein the halogen element is F.

<7> The phosphor described in any one of the above <1>-<6> wherein a is a number within the range of not less than 1 but not more than 2.

<8> A process for producing the phosphor of the above <1>, which comprises firing a metal compound mixture which contains M¹, M², M³, M⁴ and a halogen element, wherein M¹ represents an alkaline earth metal element, M² represents a trivalent metal element, M³ represents an activating element, and M⁴ represents a tetravalent metal element, the metal compound mixture containing at least one halide selected from the group consisting of halides of M¹, halides of M² and halides of M³.

<9> The process for producing the phosphor described in the above <8> wherein a holding temperature for firing is not lower than 950° C. but not higher than 1050° C.

<10> A phosphor obtained by the process described in the above <8> or <9>.

<11> A phosphor paste which contains the phosphor described in any one of the above <1>-<7> and <10>.

<12> A phosphor layer obtained by applying the phosphor paste described in the above <11> on a substrate and then heat treating the paste applied.

<13> A light emitting device which has the phosphor described in any one of the above <1>-<7> and <10>.

<14> A vacuum ultraviolet ray excited light emitting device which has the phosphor described in any one of the above <1>-<7> and <10>.

### ADVANTAGES OF THE INVENTION

The phosphor of the present invention has enhanced luminance and hence is suitable for light emitting devices, especially suitable for vacuum ultraviolet ray excited light emitting devices. Furthermore, it hardly decreases in luminance after irradiation with excitation sources, such as electron rays, ultraviolet rays, vacuum ultraviolet rays, blue LED, ultraviolet LED, and X rays, and is industrially very useful.

### BEST MODE FOR CARRYING OUT THE INVENTION

The present invention will be explained in detail below.

The present invention provides a phosphor which comprises M¹, M², M³, M⁴, a halogen element and O, wherein M¹ represents an alkaline earth metal element, M² represents a trivalent metal element, M³ represents an activating element, and M⁴ represents a tetravalent metal element, with the molar ratio of M¹:(M²+M³):M⁴:halogen element being 1:4:3:a, wherein a is a number within the range of not less than 0.01 but not more than 3.

In the present invention, options of Ware Mg, Ca, Sr and Ba, among which one element or two or more elements may be chosen. When two or more elements of them are used as M¹, the numeral value of M¹ used in the molar ratio of M¹:(M²+M³):M⁴:halogen element is a value obtained by calculating the molar numbers of the respective elements and totaling the molar numbers. The same manner can be applied to the cases when two or more elements are used as M², M³, M⁴ or the halogen element. M¹ preferably contains Ba and more preferably it is Ba for obtaining a phosphor of higher luminance.

In the present invention, options of M² are Sc, Y, La and Gd, among which one element or two or more elements may be chosen. M² preferably contains Gd and more preferably it is Gd for obtaining a phosphor of higher luminance.

In the present invention, options of M³ are Ce, Pr, Nd, Pm, Sm, Eu, Tb, Dy, Ho, Er, Tm, Yb and Mn, among which one element or two or more elements may be chosen. M³ preferably contains Tb and more preferably it is Tb for obtaining a phosphor of higher luminance.

Furthermore, in the present invention, the molar ratio of M²:M³ is usually, 3.96:0.04-3.0:1.0, preferably 3.8:0.2-3.2:0.8, and more preferably 3.6:0.4-3.2:0.8.

In the present invention, M⁴ may be Si and/or Ge. M⁴ is preferably Si for obtaining a phosphor of higher luminance.

In the present invention, options of the halogen element are F, Cl, Br and I, among which one element or two or more elements may be chosen. The halogen element preferably contains F and more preferably it is F for obtaining a phosphor of higher luminance.

In the present invention, a is a number within the range of not less than 0.01 but not more than 3, and is preferably a number within the range of not less than 0.1 but not more than 2.5, more preferably a number within the range of not less than 1 but not more than 2 for obtaining a phosphor of higher luminance.

It is a matter of course that 0 represents an oxygen atom in the present invention.

Next, the process for producing the phosphor of the present invention will be explained. The phosphor of the present invention can be produced by firing a metal compound mixture which is to be converted into the phosphor of the present invention by firing. That is, it can be produced by firing a metal compound mixture containing M¹, M², M³, M⁴ and a halogen element, wherein M¹ represents an alkaline earth metal element, M² represents a trivalent metal element, M³ represents an activating element, and M⁴ represents a tetravalent metal element.

As metal compounds containing M¹, M², M³ and M⁴ which are starting materials for the metal compound mixture, for example, oxides of M¹, M², M³ and M⁴ may be used or compounds which decompose at high temperatures to form oxides, such as hydroxides, carbonates, nitrates and oxalates, may be used. In order to have the metal compound mixture contain a halogen element, metal compounds containing M¹, M², M³ and M⁴ may be mixed with halogenated ammonium (e.g., ammonium fluoride, and ammonium chloride) or a part of the metal compounds containing M¹, M², M³ and M⁴ may be replaced with halides of M¹, M², M³ and M⁴.

For producing a phosphor having higher luminance, the metal compound mixture preferably contains at least one halide selected from the group consisting of a halide of M¹, a halide of M² and a halide of M³, more preferably contains a halide of M² and/or a halide of M³. When the metal compound mixture contains a halide of M² and/or a halide of M³, it is preferred to use a carbonate of M¹ as the metal compound containing M¹, and an oxide of M⁴ as the metal compound containing M⁴.

For example, a phosphor having a molar ratio of Ba:(Gd+Tb):Si:F being 1:(3.4+0.6):3:a, which is one of the preferred phosphors in the present invention, can be produced by firing a metal compound mixture obtained by weighing and mixing BaCO₃, Gd₂O₃, TbF₃ and SiO₂ so as to give a molar ratio of Ba:Gd:Tb:Si being 1:3.4:0.6:3. Here, a can be controlled by controlling the firing time and firing temperature referred to hereinafter.

The above mixing may be carried out by using an apparatus conventionally used in industry, such as a ball mill, a V shaped mixer and a stirrer. Furthermore, either of wet mixing or dry mixing may be employed.

The phosphor of the present invention can be obtained by firing the above metal compound mixture by keeping it, for example, in a temperature range of not lower than 900° C. but not higher than 1500° C. for a time range of not less than 0.3 hours but not more than 100 hours, though depending on the composition. Here, a in the phosphor can be controlled by controlling the firing time and the firing temperature. In the range of a, a tends to decrease with increase of firing time and firing temperature. The holding temperature for firing is preferably not lower than 950° C. but not higher than 1050° C.

The atmosphere for firing is, for example, an inert gas atmosphere, such as nitrogen and argon; an oxidizing atmosphere, such as air, oxygen, oxygen-containing nitrogen and oxygen-containing argon; or a reducing atmosphere, such as nitrogen containing 0.1-10 volume % of hydrogen or argon containing 0.1-10 volume % of hydrogen. In order to carry out the firing in a stronger reducing atmosphere, a suitable amount of carbon may be added to the atmosphere. The atmosphere in which the calcination is carried out may be either an oxidizing atmosphere, such as an air or a reducing atmosphere.

Furthermore, before the firing, the metal compound mixture may be calcined by keeping it at a temperature lower than the keeping temperature in the firing. The atmosphere in which the calcination is carried out may be any of an inert gas atmosphere, an oxidizing atmosphere and a reducing atmosphere. After the calcination, the residue may be ground.

Moreover, the phosphor obtained by the above process can be ground using a ball mill, a jet mill or the like. Further, the phosphor can be washed or classified. Further, the firing can be carried out twice or more for further improving the luminance of a phosphor to be obtained.

Next, a phosphor paste containing the phosphor of the present invention will be explained.

The phosphor paste of the present invention contains the phosphor of the present invention and organic materials as main components, and the organic materials include, for example, solvents and binders. The phosphor paste of the present invention can be used in the same manner as phosphor pastes used in production of conventional light emitting devices. That is, by heat treating the paste, the organic materials in the phosphor paste are removed by volatilization, burning or decomposition, whereby a phosphor layer comprising essentially the phosphor of the present invention can be obtained.

The phosphor paste of the present invention can be produced by a known method disclosed, for example, in JP-A-10-255671. For example, it can be obtained by mixing the phosphor of the present invention with a binder and a solvent using a ball mill, a three-roll, or the like.

Examples of the binders include cellulose resins (e.g., ethyl cellulose, methyl cellulose, nitro cellulose, acetyl cellulose, cellulose propionate, hydroxypropyl cellulose, butyl cellulose, benzyl cellulose and modified cellulose), acrylic resins (e.g., polymers of at least one of such monomers as acrylic acid, methacrylic acid, methyl acrylate, methyl methacrylate, ethyl acrylate, ethyl methacrylate, propyl acrylate, propyl methacrylate, isopropyl acrylate, isopropyl methacrylate, n-butyl acrylate, n-butyl methacrylate, tert-butyl acrylate, tert-butyl methacrylate, 2-hydroxyethyl acrylate, 2-hydroxyethyl methacrylate, 2-hydroxypropyl acrylate, 2-hydroxypropyl methacrylate, benzyl acrylate, benzyl methacrylate, phenoxy acrylate, phenoxy methacrylate, isobornyl acrylate, isobornyl methacrylate, glycidyl methacrylate, styrene, α-methylstyreneacrylamide, methacrylamide, acrylonitrile, and methacrylonitrile), ethylene-vinyl acetate copolymer resins, polyvinyl butyral, polyvinyl alcohol, propylene glycol, polyethylene oxide, urethane resins, melamine resins, phenolic resins, etc.

Examples of the solvents include monohydric alcohols having high boiling points; polyhydric alcohols, e.g., diols and triols, such as ethylene glycol and glycerin; compounds obtained by etherification and/or esterification of alcohols (e.g., ethylene glycol monoalkyl ethers, ethylene glycol dialkyl ethers, ethylene glycol alkyl ether acetates, diethylene glycol monoalkyl ether acetates, diethylene glycol dialkyl ethers, propylene glycol monoalkyl ethers, propylene glycol dialkyl ethers, and propylene glycol alkylacetates), etc.

In the phosphor paste, the phosphor of the present invention and a phosphor different from it may be mixed to be used depending on the application. Examples of the phosphors different from the phosphor of the present invention include such red light emitting phosphors as trivalent europium-activated yttrium oxide phosphor (Y₂O₃:Eu) and trivalent europium-activated yttrium oxysulfide phosphor (Y₂O₂S:Eu), and, such green light emitting phosphors as cerium and terbium-activated lanthanum phosphate (LaPO₄:Ce,Tb), and terbium-activated cerium•terbium•magnesium•aluminum phosphor ((CeTb)MgAl₁₁O₁₉:Tb). Examples of blue light emitting phosphors include europium-activated strontium phosphate phosphor (Sr₅(PO₄)₃Cl:Eu), europium-activated strontium•barium•calcium phosphate phosphor ((Sr,Ca,Ba)₅(PO₄)₃Cl:Eu), europium-activated barium•magnesium•aluminum phosphors (BaMg₂Al₁₆O₂₇:Eu, BaMgAl₁₀O₁₇:Eu, etc.), and silicate phosphors ((Sr,Ca,Ba)MgSi₂O₆:Eu, (Sr,Ca,Ba)₃MgSi₂O₈:Eu, etc.), and the like.

The phosphor layer obtained by applying the phosphor paste prepared as above on a substrate and then heat treating the paste applied is excellent in moisture resistance. The material of the substrate includes, for example, glass, resin, etc., and may be flexible and may be in the shape of a plate or a container. Furthermore, the phosphor paste can be applied by a screen printing method, an ink jet method, etc. The heat treating temperature is usually 300-600° C. Moreover, after being applied on the substrate and before being subjected to the heat treatment, the paste applied may be dried at a temperature of room temperature to 300° C.

Here, a three band fluorescent lamp, which is an ultraviolet ray excited light emitting device, is taken as an example of light emitting devices having the phosphor of the present invention, and a method for producing it will be explained. For example, a known method disclosed in JP-A-2004-2569 may be used as a method for producing a three band fluorescent lamp. That is, a phosphor paste is prepared, for example, by dispersing a three band emitting type phosphor obtained by mixing suitably a blue light emitting phosphor, a green light emitting phosphor and a red light emitting phosphor so that color of emitted light may become desired white, in an aqueous polyethylene oxide solution. This phosphor paste is applied on the inner surface of a glass bulb, followed by baking at a temperature of, for example, 400-900° C. to form a phosphor layer. Thereafter, a three band fluorescent lamp can be produced through usual steps of sealing of stem to end portions of the glass bulb, exhaustion of the bulb, charging of mercury and rare gas, sealing of exhaustion tube, fitting of a base, etc.

Next, a plasma display panel which is a vacuum ultraviolet ray excited light emitting device is taken as an example of light emitting device having the phosphor of the present invention and a method for producing it will be explained. For example, a known method disclosed in JP-A-10-195428 (U.S. Pat. No. 6,099,753) may be used as a method for producing a plasma display panel. That is, the respective phosphors comprising green light emitting phosphor, red light emitting phosphor and the blue light emitting phosphor are respectively mixed with a binder comprising, for example, a cellulose resin or polyvinyl alcohol and a solvent to prepare phosphor pastes. The phosphor paste is applied on a substrate surface formed in a stripe shape and partitioned by partition walls on the inner face of a rear face substrate and having address electrodes, and partition wall faces by a method such as screen printing and are heat treated at 300-600° C., so that respective phosphor layers are formed. On the respective phosphor layers is then overlapped and adhered a surface glass substrate in which transparent electrodes and bus electrodes are arranged in a direction perpendicular to each of the phosphor layers and a dielectric layer and a protecting layer are arranged on an inner face of this surface glass substrate. A discharging space is formed by exhausting the inside and charging therein low-pressure rare gas such as Xe or Ne so that a plasma display panel is manufactured.

Next, a field emission display, which is an electron ray excited light emission device, is taken as an example of the light emitting device having the phosphor of the present invention, and a method for producing the field emission display will be explained. For example, a known method disclosed in JP-A-2002-138279 may be used as a method for producing a field emission display. That is, phosphors comprising respectively a green light emitting phosphor, a red light emitting phosphor and a blue light emitting phosphor are respectively dispersed, for example, in aqueous polyvinyl alcohol solutions to prepare phosphor pastes. The phosphor pastes are applied on a glass substrate and then heat treated to form phosphor layers to obtain a face plate. The face plate and a rear plate having many electron emitter are fabricated using a supporting frame, and simultaneously usual steps such as hermetic sealing while vacuum exhausting the spaces between the plates are carried out, whereby a field emission display can be produced.

Next, white LED is taken as an example of the light emitting device having a phosphor of the present invention, and a method for producing it will be explained. For producing the white LED, there may be used known methods as disclosed, for example, in JP-A-5-152609 and JP-A-7-99345. That is, a phosphor containing at least the phosphor of the present invention is dispersed in a light transmitting resin such as epoxy resin, polycarbonate or silicone rubber, and the resin in which the phosphor is dispersed is molded so that the resin surrounds blue LED or ultraviolet LED, and thus a white LED can be produced.

### EXAMPLES

The present invention will be explained in more detail by the following examples, which should not be construed as limiting the invention.

Measurement of luminance was conducted by placing a phosphor in a vacuum tank, keeping it under vacuum of 6.7 Pa(5×10⁻² Torr) or lower, and irradiating the phosphor with vacuum ultraviolet rays using an excimer 146 nm lamp (model H0012 manufactured by Ushio Inc.) or an excimer 172 nm lamp (model H0016 manufactured by Ushio Inc.).

The content of the halogen element in a phosphor was measured by the following method.

That is, 1 g of phosphor powder sample weighed was charged in a distillation flask together with pyrophosphoric acid, the phosphor powder was dissolved by heating, then steam was introduced into the flask (kept at 145° C.), the halogen element was sufficiently extracted into the steam side, and the steam was cooled to obtain a halogen extraction solution (about 500 ml of the halogen extraction solution is necessary).

Using the resulting halogen extraction solution, quantitative analysis on the content of halogen element is conducted. When the halogen element is fluorine, quantitative analysis may be carried out on fluorine using an ion electrode apparatus (e.g., Model Orion 920A manufactured by Thermofisher Scientific K.K.), and when it is chlorine, the extraction solution may be analyzed using an ion chromatograph (e.g., DX-120 manufactured by Dionex Corp.).

The powder X-ray diffraction pattern of a phosphor was measured by a powder X-ray diffractometry using CuKα characteristic X-ray. An X-ray diffraction analyzer (model RINT2500TTR manufactured by Rigaku Corp.) was used as a measuring apparatus.

### Comparative Example 1

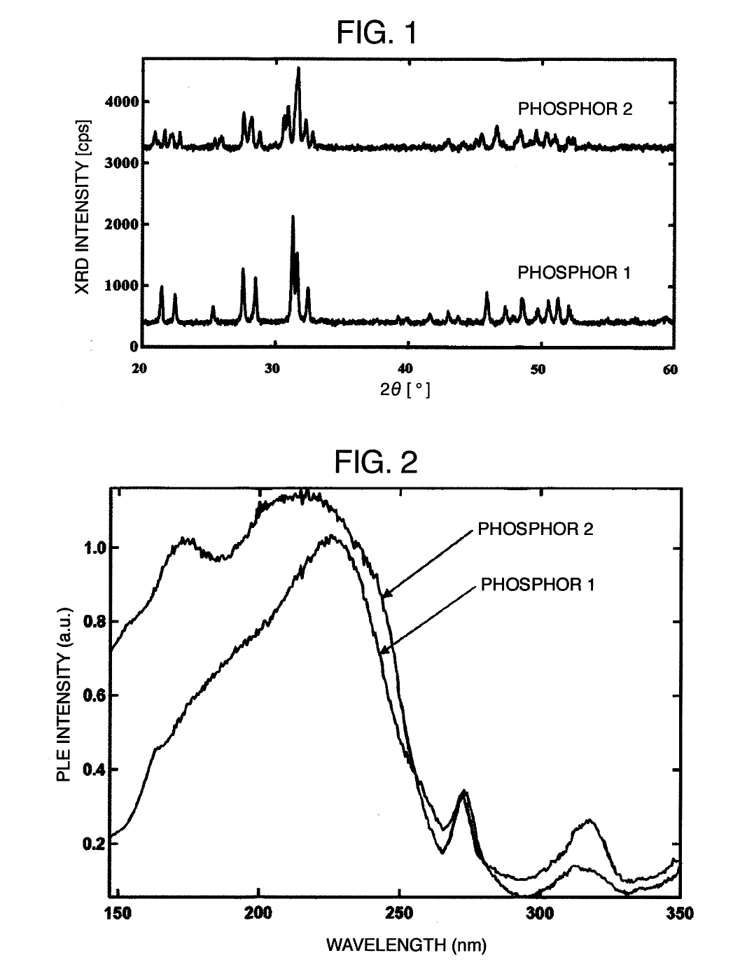

Barium carbonate (manufactured by Kanto Chemical Co., Ltd.; purity: 99.99%), gadolinium oxide (manufactured by Shin-Etsu Chemical Co., Ltd.; purity: 99.99%), terbium oxide (manufactured by. Shin-Etsu Chemical Co., Ltd.; purity: 99.99%), and silicon dioxide (manufactured Wako Pure Chemical Industries Ltd.; purity: 99.99%) were weighed so as to give a molar ratio of Ba:Gd:Tb:Si being 1:3.4:0.6:3, and they were mixed. The mixture was fired by keeping it at 1400° C. for 3 hours in an atmosphere of N₂ containing 2 vol % of H₂, followed by slowly cooling it to room temperature to obtain phosphor 1. The X-ray diffraction pattern of phosphor 1 is shown in FIG. 1. It was found from FIG. 1 that the phosphor 1 was a phosphor represented by BaGd_{3.4}Tb_{0.6}Si₃O₁₃. Further, the fluorine (F) content in the phosphor 1 was measured to be 24 ppm.

When the phosphor 1 was irradiated with vacuum ultraviolet rays in a vacuum tank of 6.7 Pa(5×10⁻² Torr) or lower at room temperature (about 25° C.) using an excimer 146 nm lamp (model H0012 manufactured by Ushio Inc.), the phosphor 1 showed green light emission, and the luminance obtained was assumed to be 100.

When the phosphor 1 was irradiated with vacuum ultraviolet rays in a vacuum tank of 6.7 Pa(5×10⁻² Torr) or lower at room temperature (about 25° C.) using an excimer 172 nm lamp (model H0016 manufactured by Ushio Inc.), the phosphor 1 showed green light emission, and the luminance obtained was assumed to be 100.

A binder (e.g., a mixture of ethyl cellulose and isopropanol at 1:9) was added to the phosphor 1, followed by kneading. Then the kneaded product was kept in the air at 600° C. for 30 minutes to remove the binder. Then, when the resulting phosphor was irradiated with vacuum ultraviolet rays in a vacuum tank of 6.7 Pa(5×10⁻² Torr) or lower at room temperature (about 25° C.) using an excimer 146 nm lamp (model H0012 manufactured by Ushio Inc.), the phosphor showed green light emission, and the luminance obtained was nearly the same as that of the phosphor 1 (change of luminance was within 2% as compared with the luminance of the phosphor 1).

### Example 1

Barium carbonate (manufactured by Kanto Chemical Co., Ltd.; purity: 99.99%), gadolinium oxide (manufactured by Shin-Etsu Chemical Co., Ltd.; purity: 99.99%), terbium fluoride (manufactured by Kanto Chemical Co., Ltd.; purity: 99.99%), and silicon dioxide (manufactured Wako Pure Chemical Industries Ltd.; purity: 99.99%) were weighed so as to give a molar ratio of Ba:Gd:Tb:Si being 1:3.4:0.6:3, and they were mixed. The mixture was fired by keeping it at 1000° C. for 3 hours in an atmosphere of N₂ containing 2 vol % of H₂, followed by slowly cooling it to room temperature to obtain phosphor 2. The X-ray diffraction pattern of phosphor 2 is shown in FIG. 1. It was found from FIG. 1 that the X-ray diffraction pattern of phosphor 2 was different from that of phosphor 1. It was further found that the content of fluorine (F) in the phosphor 2 was 25000 ppm, and the molar ratio of Ba:(Gd+Tb):Si:F in the phosphor 2 was 1:4:3:1.4.

When phosphor 2 was irradiated with vacuum ultraviolet rays in a vacuum tank of 6.7 Pa(5×10⁻² Torr) or lower at room temperature (about 25° C.) using an excimer 146 nm lamp (model H0012 manufactured by Ushio Inc.), the phosphor 2 showed green light emission, and the luminance obtained was 360 (the luminance of phosphor 1 being assumed to be 100).

When phosphor 2 was irradiated with vacuum ultraviolet rays in a vacuum tank of 6.7 Pa(5×10⁻² Torr) or lower at room temperature (about 25° C.) using an excimer 172 nm lamp (model H0016 manufactured by Ushio Inc.), the phosphor 2 showed green light emission, and the luminance obtained was 219 (that of phosphor 1 being assumed to be 100).

A binder (e.g., a mixture of ethyl cellulose and isopropanol at 1:9) was added to the phosphor 2, followed by kneading. Then the kneaded product was kept at 600° C. for 30 minutes in the air to remove the binder. Then, when the resulting phosphor was irradiated with vacuum ultraviolet rays in a vacuum tank of 6.7 Pa(5×10⁻² Torr) or lower at room temperature (about 25° C.) using an excimer 146 nm lamp (model H0012 manufactured by Ushio Inc.), the phosphor showed green light emission, and the luminance obtained was nearly the same as that of the phosphor 2 (change of luminance was within 2% as compared with the luminance of the phosphor 2).

### Example 2

Barium carbonate (manufactured by Kanto Chemical Co., Ltd.; purity: 99.99%), gadolinium oxide (manufactured by Shin-Etsu Chemical Co., Ltd.; purity: 99.99%), gadolinium fluoride (manufactured by Kanto Chemical Co., Ltd.; purity: 99.99%), terbium oxide (manufactured by Shin-Etsu Chemical Co., Ltd.; purity: 99.99%), and silicon dioxide (manufactured Wako Pure Chemical Industries Ltd.; purity: 99.99%) were weighed so as to give a molar ratio of barium carbonate (BaCO₃):gadolinium oxide (Gd₂O₃):gadolinium fluoride (GdF₃):terbium oxide (Tb₄O₇):silicon dioxide (SiO₂) being 1:1.4:0.6:0.15:3, and they were mixed. The mixture was fired by keeping it at 1000° C. for 3 hours in an atmosphere of N₂ containing 2 vol % of H₂, followed by slowly cooling it to room temperature to obtain phosphor 3. When the content of fluorine (F) in the phosphor 3 was measured to be 25000 ppm, and it was found that the molar ratio of Ba:(Gd+Tb):Si:F in the phosphor 3 was 1:4:3:1.4.

When phosphor 3 was irradiated with vacuum ultraviolet rays in a vacuum tank of 6.7 Pa(5×10⁻² Torr) or lower at room temperature (about 25° C.) using an excimer 146 nm lamp (model H0012 manufactured by Ushio Inc.), the phosphor 3 showed green light emission, and the luminance obtained was 305 (that of phosphor 1 being assumed to be 100).

When phosphor 3 was irradiated with vacuum ultraviolet rays in a vacuum tank of 6.7 Pa(5×10⁻² Torr) or lower at room temperature (about 25° C.) using an excimer 172 nm lamp (model H0016 manufactured by Ushio Inc.), the phosphor 3 showed green light emission, and the luminance obtained was 199 (that of phosphor 1 being assumed to be 100).

A binder (e.g., a mixture of ethyl cellulose and isopropanol at 1:9) was added to the phosphor 3, followed by kneading. Then the kneaded product was kept at 600° C. for 30 minutes in the air to remove the binder. Then, when the resulting phosphor was irradiated with vacuum ultraviolet rays in a vacuum tank of 6.7 Pa(5×10⁻² Torr) or lower at room temperature (about 25° C.) using an excimer 146 nm lamp (model H0012 manufactured by Ushio Inc.), the phosphor showed green light emission, and the luminance obtained was nearly the same as that of the phosphor 3 (change of luminance was within 2% as compared with the luminance of the phosphor 3).

### Example 3

Barium carbonate (manufactured by Kanto Chemical Co., Ltd.; purity: 99.99%), gadolinium oxide (manufactured by Shin-Etsu Chemical Co., Ltd.; purity: 99.99%), gadolinium fluoride (manufactured by Kanto Chemical Co., Ltd.; purity: 99.99%), terbium oxide (manufactured by Shin-Etsu Chemical Co., Ltd.; purity: 99.99%), terbium fluoride (manufactured by Kanto Chemical Co., Ltd.; purity: 99.99%) and silicon dioxide (manufactured Wako Pure Chemical Industries Ltd.; purity: 99.99%) were weighed so as to give a molar ratio of barium carbonate (BaCO₃):gadolinium oxide (Gd₂O₃):gadolinium fluoride (GdF₃):terbium oxide (Tb₄O₇):terbium fluoride (TbF₃):silicon dioxide (SiO₂) being 1:1.55:0.3:0.075:0.3:3, and they were mixed. Then, the mixture was fired by keeping it at 1000° C. for 3 hours in an atmosphere of N₂ containing 2 vol % of H₂, followed by slowly cooling it to room temperature to obtain phosphor 4. When the content of fluorine (F) in the phosphor 4 was measured to be 25000 ppm, and it was found that the molar ratio of Ba:(Gd+Tb):Si:F in the phosphor 4 was 1:4:3:1.4.

When the phosphor 4 was irradiated with vacuum ultraviolet rays in a vacuum tank of 6.7 Pa(5×10⁻² or lower at room temperature (about 25° C.) using an excimer 146 nm lamp (model H0012 manufactured by Ushio Inc.), the phosphor 4 showed green light emission, and the luminance obtained was 303 (that of phosphor 1 being assumed to be 100).

When the phosphor 4 was irradiated with vacuum ultraviolet rays in a vacuum tank of 6.7 Pa(5×10⁻² Torr) or lower at room temperature (about 25° C.) using an excimer 172 nm lamp (model H0016 manufactured by Ushio Inc.), the phosphor 4 showed green light emission, and the luminance obtained was 198 (that of phosphor 1 being assumed to be 100).

A binder (e.g., a mixture of ethyl cellulose and isopropanol at 1:9) was added to the phosphor 4, followed by kneading. Then the kneaded product was kept at 600° C. for 30 minutes in the air to remove the binder. Then, when the resulting phosphor was irradiated with vacuum ultraviolet rays in a vacuum tank of 6.7 Pa(5×10⁻² Torr) or lower at room temperature (about 25° C.) using an excimer 146 nm lamp (model H0012 manufactured by Ushio Inc.), the phosphor showed green light emission, and the luminance obtained was nearly the same as that of the phosphor 4 (change of luminance was within 2% as compared with the luminance of the phosphor 4).

### INDUSTRIAL APPLICABILITY

The phosphor of the present invention has enhanced luminance and hence is suitable for light emitting devices, especially suitable for vacuum ultraviolet ray excited light emitting devices. Furthermore, it shows less decrease in luminance after irradiation with excitation sources such as electron rays, ultraviolet rays, vacuum ultraviolet rays, blue LED, ultraviolet LED, and X rays, and is industrially very useful.

### BRIEF DESCRIPTION OF DRAWINGS

[FIG. 1] Powder X-ray diffraction patterns of phosphor 1 and phosphor 2.

[FIG. 2] Excitation spectra of phosphor 1 and phosphor 2 (the abscissa axis indicating excitation wavelength and the ordinate axis indicating emission intensity).

1. A phosphor which comprises M¹, M², M³, M⁴, a halogen element and O, wherein M¹ represents an alkaline earth metal element, M² represents a trivalent metal element, M³ represents an activating element, and M⁴ represents a tetravalent metal element, with the molar ratio of M¹:(M²+M³):M⁴:halogen element being 1:4:3:a wherein a is a number within the range of not less than 0.01 but not more than 3.

2. The phosphor according to claim 1 wherein M¹ contains Ba.

3. The phosphor according to claim 1 wherein M² contains Gd.

4. The phosphor according to claim 1 wherein M³ contains Tb.

5. The phosphor according to claim 1 wherein M⁴ contains Si.

6. The phosphor according to claim 1 wherein the halogen element is F.

7. The phosphor according to claim 1 wherein a is a number within the range of not less than 1 but not more than 2.

8. A process for producing the phosphor of claim 1, which comprises firing a metal compound mixture which contains M¹, M², M³, M⁴ and a halogen element, wherein M¹ represents an alkaline earth metal element, M² represents a trivalent metal element, M³ represents an activating element, and M⁴ represents a tetravalent metal element, the metal compound mixture containing at least one halide selected from the group consisting of halides of M¹, halides of M² and halides of M³.

9. The process for producing the phosphor according to claim 8 wherein a holding temperature for firing is not lower than 950° C. but not higher than 1050° C.

10. A phosphor obtained by the process according to claim 8.

11. A phosphor paste which contains the phosphor of claim 1.

12. A phosphor layer obtained by applying the phosphor paste of claim 11 on a substrate and then heat treating the paste applied.

13. A light emitting device which has the phosphor of claim 1.

14. A vacuum ultraviolet ray excited light emitting device which has the phosphor of claim 1.
